(19) United States
(12) Patent Application Publication
(10) Pub. No.: US 2018/0160842 A1
(43) Pub. Date: Jun. 14, 2018

(54) Flavored Coffee, Tea Filters

(71) Applicant: Gair Dunham, Columbia City, IN (US)

(72) Inventor: Gair Dunham, Columbia City, IN (US)

(21) Appl. No.: 15/377,975

(22) Filed: Dec. 13, 2016

(51) Int. Cl. A47J 31/08

(52) U.S. Cl. CPC A47J 31/08

(57) ABSTRACT

A method of making a flavored filter, the method comprises extracting a flavor from a flavor source; applying the flavor on a filter; and drying the sprayed filter. In another example embodiment, a method of making a composite flavored filter further includes extracting a first flavor from a first flavor source; spraying the first flavor on a first filter; extracting a second flavor from a second flavor source; spraying the second flavor on a second filter; drying the first filter and the second first filter separately; and combining the dried first filter and dried second filter to form a composite flavored coffee filter.

### FIELD

Example embodiments described herein generally relate to a system and apparatus for making a drink flavoring filter.

### BACKGROUND

U.S. Patent No. 20050034607 A1 to Stevenson, discusses filter/flavored coffee filter inserts that are designed to be used with brewed coffee. The filters are treated with a special flavor that will dispense when permeated with hot water which will be absorbed into the coffee grinds causing the coffee to be flavored with whatever flavor was put onto the coffee filter. The advantage of the flavored coffee filter/flavored coffee filter inserts is it will allow you to experience different flavors with your plain coffee.

U.S. Pat. No. 4,975,292 A to Loizzi, discusses flavored inserts which can be impregnated with a desired flavor and placed inside of a conventional coffee filter. The insert permits the brewing water to filter through the filter without obstruction while imparting the desired flavor to the brewing water. The entire filter can be so flavored, or at least the bottom thereof, and the flavored insert and/or flavored filter can be used to impart flavoring to various beverages, such as tea, soft drinks, etc.

Conventional systems or methods of flavoring drinks are directed to flavoring inserts, or providing a flavoring separately from the filter. The invention relates to drink flavoring filters that comprise a favoring embedded in at least one filter, such as may be used as a coffee filter and/or a tea filter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be made to the accompanying drawings and descriptive matter in which there are illustrated preferred embodiments of the invention.

Additional features and advantages of the invention will be set forth in the detailed description which follows, and in part will be readily apparent to those skilled in the an from that description or recognized by practicing the invention as described herein, including the detailed description.

### SUMMARY

The inventive aspects described in the specification can be embodied in a method of making a flavored filter. The further inventive aspects can be embodied in causing an extraction of at least one flavoring; causing a processing of the at least one flavoring; and causing an application of the at least one flavoring to a filter material. The other inventive aspects can be embodied in a method for flavoring a filter, wherein the at least one flavoring includes a fruit flavoring, a coffee flavoring, or a tea flavoring. Yet other inventive aspects can be embodied in a processing that includes a drying of the at least one flavoring and an embedding of the at least on flavoring in one or more structures of the filter material. The further inventive aspects can be embodied in a pressing of the filter material with the at least one flavoring to form a unitary flavored filter or a spraying of the filter material with the at least one flavoring to form a unitary flavored filter.

The inventive aspects described in the specification can be embodied in a method of making a composite flavored coffee filter, the method comprising: extracting a first flavor from a first flavor source; spraying the first flavor on a first coffee filter; and extracting a second flavor from a second flavor source; spraying the second flavor on a second coffee filter; drying the first coffee filter and the second first coffee filter, and combining the dried first coffee filter and the dried second first coffee filter to form a composite flavored coffee filter.

The inventive aspects include combining a flavoring product with a coffee filter, tea filter, or another like filter. The flavoring may comprise various fruit flavors such as lemon, grape, apple, lime, coconut, and other like flavors. The flavoring may comprise a combination of fruit flavors, such as, for example, mango-orange. The flavoring may comprise coffee or tea.

### BRIEF DESCRIPTION OF THE DRAWINGS

FIG. 1 shows a flavored filter, according to an example embodiment.

FIG. 2 shows composite flavored coffee filter with two favor, according to an example embodiment.

FIG. 3 shows composite flavored coffee filter with two filters, according to an example embodiment.

FIG. 4 shows a composite filter pack of three layers, according to an example embodiment.

FIG. 5 shows a composite filter pack of four layers, according to an example embodiment.

### DETAILED DESCRIPTION

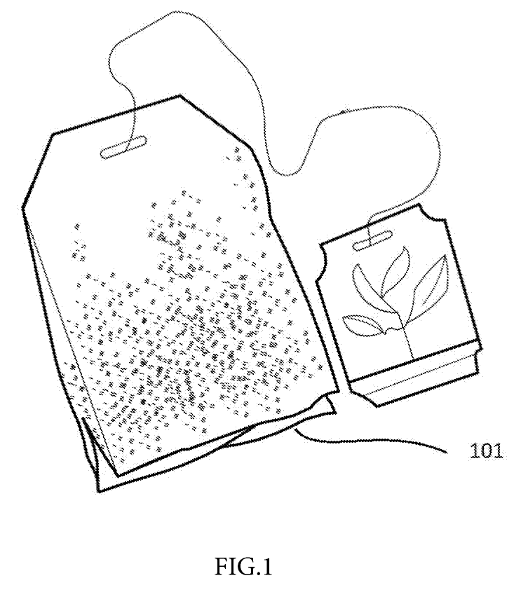

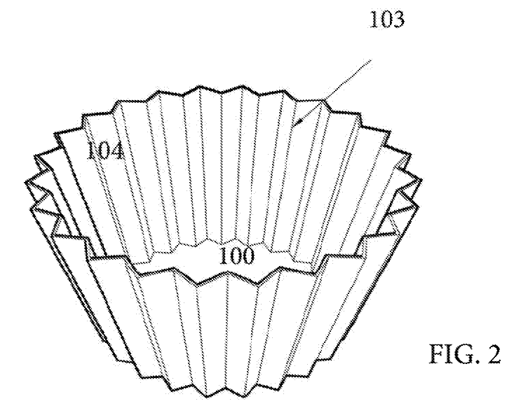

FIGS. 1-2. show a system for providing a flavored filter, according to an example embodiment. The flavoring may be used with filters 101 and 103. In one example embodiment, a flavoring filter includes a flavoring spray coated onto a filter. Thus, the filter may be used without any additional components. The flavoring filter may be used with other components such as coffee grounds, tea leaves, juice, alcoholic beverages, and other like drinks to be flavored. Thus, a user may add addition components to a premade flavored filter.

FIG. 2 shows composite flavored coffee filter according to an example embodiment. The multiple flavoring may be used with a single filter 104. Such flavoring filter includes a first flavoring spray coated onto a filter and a second flavoring spray coated onto the same filter. The filter may be used without any additional components to create a flavored drink incorporating the first flavor and the second flavor. In one embodiment, three or more flavorings may be incorporated into a single filter and subsequently be used to create a flavored drink with the three or more flavorings. In one embodiment, the flavoring filter may be used with other components such as coffee grounds, tea leaves, juice, alcoholic beverages, and other like drinks to be flavored. Thus, a user may add addition components to a premade flavored filter with a first flavoring and a second flavoring.

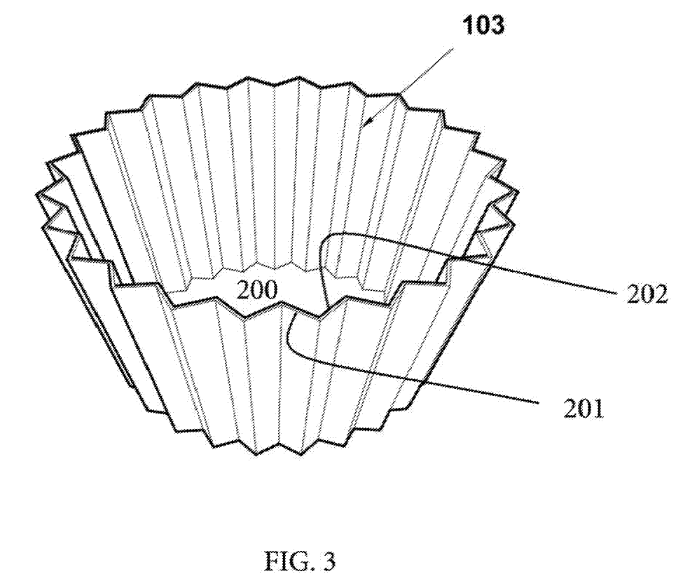

In another example embodiment, a first flavored filter may be combined with a second flavored filter to create a composite flavored filter for flavoring a drink. As shown in FIG. 3, a flavored filter includes a first flavoring spray coated onto a first filter 201 and a second flavoring spray coated onto a second filter 202. The first filter 201 and the second filter 202 may be combined to form a composite filter and may be used without any additional components to create a flavored drink incorporating a first flavor and a second flavor.

In another example embodiment, three or more flavored filters 10, 20, 30 may be combined to create a composite flavored filter wherein each flavor is spray coated onto each of the separate filters, dried separately and combined into a composite flavored filter to be used to flavor a drink. The composite flavored filter may be used with various components such as coffee grounds, tea leaves, juice, alcoholic beverages, and other like drinks to be flavored. Thus, a user may add additional components to a premade composite flavored filter with a first flavored filter and a second flavored filter. The advantage of such composite filter is that the different flavors do not have be deposited on the same single layer filter during the formation of a multiflavored filter. Spraying each flavor in separate filter, drying them separately, and packing them in a composite filter of two, three or four layers, each layer having different flavor, retains the freshness of each flavor until it is used.

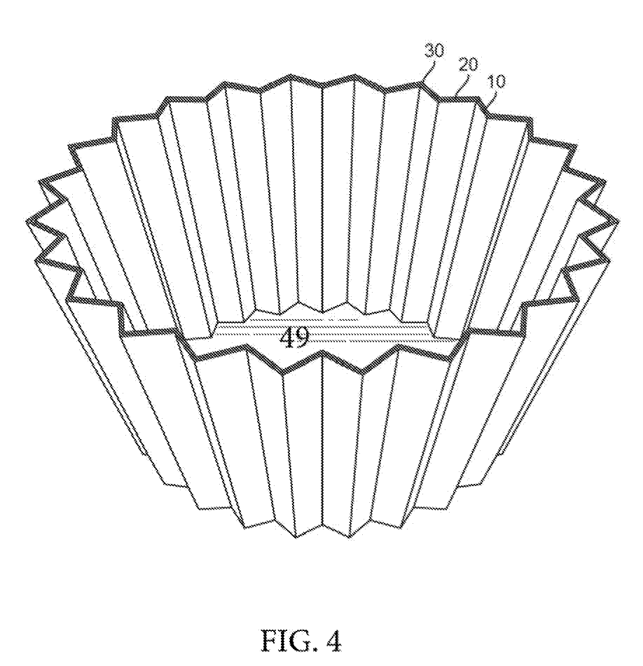

FIG. 4 shows a composite filter pack of three layers 30, 20, 10, wherein each layer have deposited separate flavor so that each of the flavors are retained fresh in each layer. Bottom 49 also include layers 30, 20 and 10.

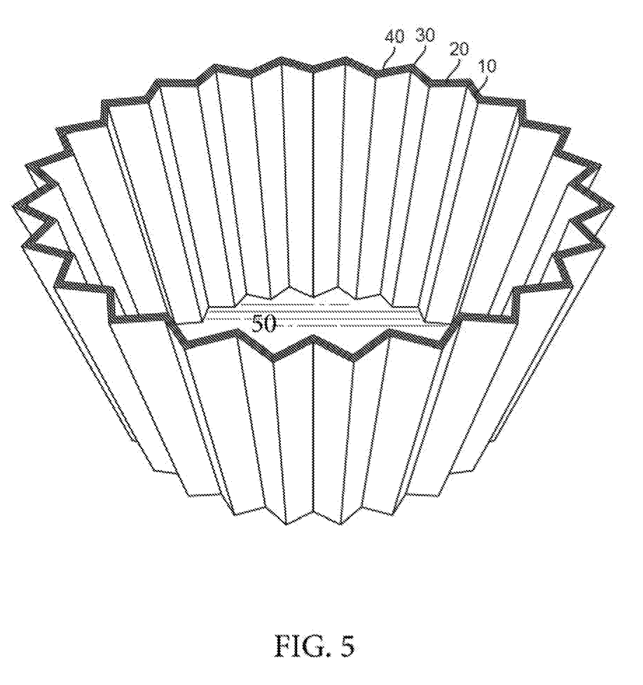

FIG. 5 shows a composite filter pack of four layers 40, 30, 20, 10, wherein each layer have deposited separate flavor so that each of the flavors are retained fresh in each layers. The bottom 50 also include layers 40, 30, 20, 10.

In one example embodiment, the flavoring may be embedded in a pocket-like structures; or between, on top of, or around undulations in the filter. The components may consist essentially of a filter material and a flavoring. The components may also include a flavoring mixed with another component and formed into a shape of a filter. Thus, the flavoring may be pressed with the filter and be a part of the filter.

In another example embodiment, a user may use conventional coffee grounds or tea leaves in the filter to flavor the coffee or tea, respectively, with the flavored filter. The user may make a specialty coffee drink with a flavored filter like hazelnut coffee from a hazelnut flavored filter. Likewise, the flavored filter may be used with other premade beverages including tea, juice, alcoholic beverages, and other like drinks to be flavored. For example, a mango flavored filter may be used to flavor another kind of juice, such as orange juice.

In yet another embodiment, the user may use the flavored filter to flavor water and create a flavored drink. For example, a mango flavored filter may be used to flavor water to make a mango flavored drink. In one embodiment, a fruit flavored filter may be used to flavor an alcoholic beverage. In another embodiment, an alcoholic beverage filter may be used to flavor a juice. Thus, a selected flavoring filter may be combined with any beverage per the desire of at least one user.

In yet another example embodiment, a method of making a flavored filter may comprise extracting a component flavor, such as coffee, tea, and various fruit flavors, and drying the component. For example, a fruit juice may be extracted from a source and dried. The dried fruit juice may be further modified, such as by pulverizing, grinding, pressing, extruding, and/or other like methods. The dried fruit juice may then be spray coated on, soaked onto, or pressed with at least one filter. In one embodiment, the dried fruit juice may be added as a powder to at least one tea bag.

In one embodiment, a method of making a flavored filter may comprise extracting an alcoholic beverage component, and drying the component. The alcoholic beverage component may then be spray coated on, soaked onto, or pressed with at least one filter. In one embodiment, the alcoholic beverage component be added as a powder to at least one tea bag.

It is to be understood that the above description is intended to be illustrative, and not restrictive. For example, the above-discussed embodiments may be used in combination with each other. Many other embodiments will be apparent to those of skill in the art upon reviewing the above description.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

What is claimed is:

1. A method of making a flavored filter, the method comprising:
extracting a flavor from a flavor source;
applying the flavor on a filter; and
drying the sprayed filter.

2. The method of claim 1, wherein the flavor includes one of a fruit flavor, a coffee flavor and combination thereof.

3. The method of claim 1, wherein applying the flavor includes spraying the flavor on the filter.

4. The method of claim 1, wherein applying includes pressing the filter material with the at least one flavor to form the flavored filter.

5. A method of making a composite flavored filter, the method comprising:
extracting a first flavor from a first flavor source;
applying the first flavor on a first filter; and
extracting a second flavor from a second flavor source;
applying the second flavor on a second filter;
drying the first filter and the second first filter separately; and
combining the dried first coffee filter and dried second coffee filter to form a composite flavored coffee filler.

6. The method of claim 5, wherein the first flavor includes one of a first fruit flavor and a first coffee flavor and the second flavor includes one of a second fruit flavor and a second coffee flavor.

7. The method of claim 5, wherein coffee grounds are added to the composite coffee filter to create a flavored coffee drink.

8. The method of claim 5, wherein the composite filter is used to flavor one of water, fruit juice, coffee, and tea.

9. A method of making a composite flavored coffee filter, the method comprising:
extracting a first flavor from a first flavor source;
spraying the first flavor on a first filter;
extracting a second flavor from a second flavor source;
spraying the second flavor on a second filter;
extracting a third flavor from a third flavor source;
spraying the third flavor on a third filter,
drying the first filter and the second first and third filter separately; and
combining the dried first filter and dried second filter and dried third filter to form the composite flavored coffee filter of three layers.
